(19) United States
(12) Patent Application Publication
(10) Pub. No.: US 2013/0344303 A1
(43) Pub. Date: Dec. 26, 2013

(54) LAYERED STRUCTURE AND METHOD OF MANUFACTURING A LAYERED STRUCTURE

(71) Applicants: Paul Randall, Swedesboro, NJ (US); Guinevere Kunkel, Sicklerville, NJ (US)

(72) Inventors: Paul Randall, Swedesboro, NJ (US); Guinevere Kunkel, Sicklerville, NJ (US)

(21) Appl. No.: 13/915,138

(22) Filed: Jun. 11, 2013

Related U.S. Application Data
(60) Provisional application No. 61/658,249, filed on Jun. 11, 2012.

(51) Int. Cl. A47B 85/06; B05D 7/00; B32B 3/10

(52) U.S. Cl. CPC A47B 85/06; B32B 3/10; B05D 7/56
USPC 428/201; 427/407.1; 427/379; 108/15

(57) ABSTRACT

A layered surface is provided that includes a first, second, third and fourth layer. The first layer includes a mixture of cement and acrylic resin. The first layer is further formed from two sub-layers. The first sub layer includes a mixture of cement and acrylic resin and has a ratio of cement to acrylic resin of approximately 10 to 1. The second sub-layer has a mixture of cement and acrylic resin at a ratio of cement to acrylic is greater than that of the first sub-layer. The second layer includes a colorant, the third layer includes an epoxy resin, and the fourth layer includes a wax.

### CROSS REFERENCE TO RELATED APPLICATIONS

The present application claims the benefit of U.S. Provisional Patent Application No. 61/658,249 filed Jun. 11, 2012 entitled “A Layered Structure and Method of Manufacturing a Layered Structure” the entire disclosure of which is hereby incorporated herein by reference.

### BACKGROUND OF THE INVENTION

The present invention relates to a layered structure having a plurality of layers including a cement/acrylic resin layer and an acrylic colorant layer. The layered structure can further include an epoxy layer and a wax layer. The present invention also relates to a method of manufacturing the layered structure. Lastly, the present invention relates to a convertible furniture piece suitable as a decorative wall piece.

### BRIEF SUMMARY OF THE INVENTION

In a preferred embodiment the present invention provides a layered structure that includes a substrate, a first layer, a second layer connected to the first layer, a third layer connected to the second layer, and an optional fourth layer connected to the third layer. The first layer includes a mixture of cement and an acrylic resin. The second layer includes a colorant. The third layer includes an epoxy. The fourth layer includes wax.

In accordance with another preferred embodiment the, the present invention provides a method of creating a layered structure. The method includes the steps of providing a substrate and applying a first layer that includes a mixture of cement and an acrylic resin to the substrate. The method further includes the steps of applying an optional sub-layer that includes cement and acrylic resin to the first layer, applying a second layer that includes a colorant to the first layer or the optional sub-layer, applying a third layer that includes a colorant and an epoxy to the second layer and applying an optional fourth layer that includes wax to the third layer.

In accordance with yet another preferred embodiment the present invention provides a convertible furniture piece that includes a frame and a colored cementitious structure. The frame is configured to be moveable between an extended configuration and a collapsed configuration. In the extended configuration the frame includes a substantially planar surface, at least three metallic mounting brackets connected to an underside of the substantially planar surface, and at least three support members releasably attached to the at least three metallic mounting brackets for supporting the frame on a ground surface. In the collapsed configuration the frame includes retaining members releasably attached to at least two of the at least three metallic mounting brackets for mounting the frame to a vertical surface, and wherein the support members are separated from the mounting brackets. The colored cementitious structure is mounted to a topside of the substantially planar surface.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a perspective view of a table in accordance with a preferred embodiment of the present invention;

FIG. 2 is a bottom plan view of the table top of FIG. 1 without legs;

FIG. 3 is an elevation side view of a table leg of the table of FIG. 1;

FIG. 4 is an enlarged partial bottom plan view of a mounting bracket of the table of FIG. 1;

FIG. 5 is a partial cross-sectional schematic view of a layered structure in accordance with a preferred embodiment of the present invention;

FIG. 5A is a partial cross-sectional schematic view of a layered structure in accordance with another preferred embodiment of the present invention;

FIG. 6 is a photograph of an exemplary top surface of the layered structure of FIG. 5. in accordance with a preferred embodiment of the present invention;

FIG. 7 is a photograph of another exemplary top surface of the layered structure of FIG. 5;

FIG. 8 is a photograph of a yet another exemplary top surface of the layered structure of FIG. 5;

FIG. 9 is a photograph of another exemplary top surface of the layered structure of FIG. 5; and

FIG. 10 is a perspective view of a foot pad applicable to the table of FIG. 1.

### DETAILED DESCRIPTION OF THE INVENTION

Reference will now be made in detail to the present embodiments of the invention illustrated in the accompanying drawings. Wherever possible, the same or like reference numbers will be used throughout the drawings to refer to the same or like features. It should be noted that the drawings are in simplified form and are not drawn to precise scale. Such directional terms used in conjunction with the following description of the drawings should not be construed to limit the scope of the invention in any manner not explicitly set forth.

Certain terminology is used in the following description for convenience only and is not limiting. The words “right,” “left,” “lower” and “upper” designate directions in the drawings to which reference is made. The words “inwardly” and “outwardly” refer to directions toward and away from, respectively, the geometric center of the identified element and designated parts thereof. Additionally, the term “a,” as used in the specification, means “at least one.” The terminology includes the words noted above, derivatives thereof and words of similar import.

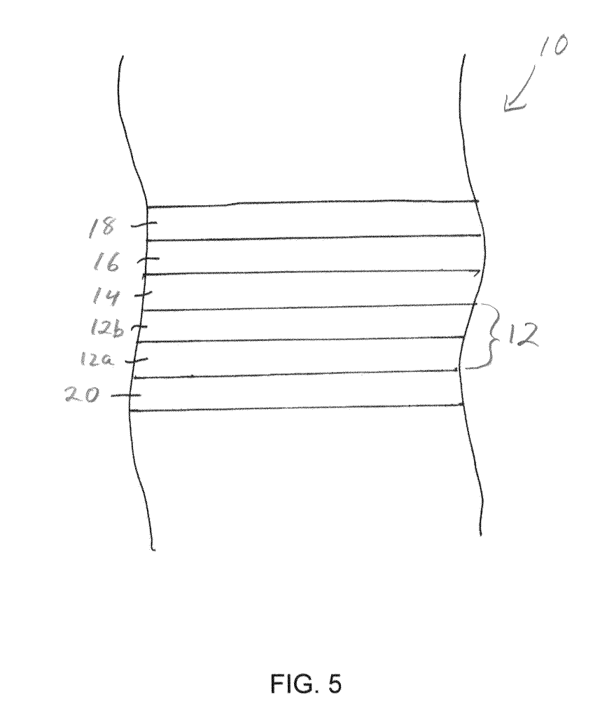

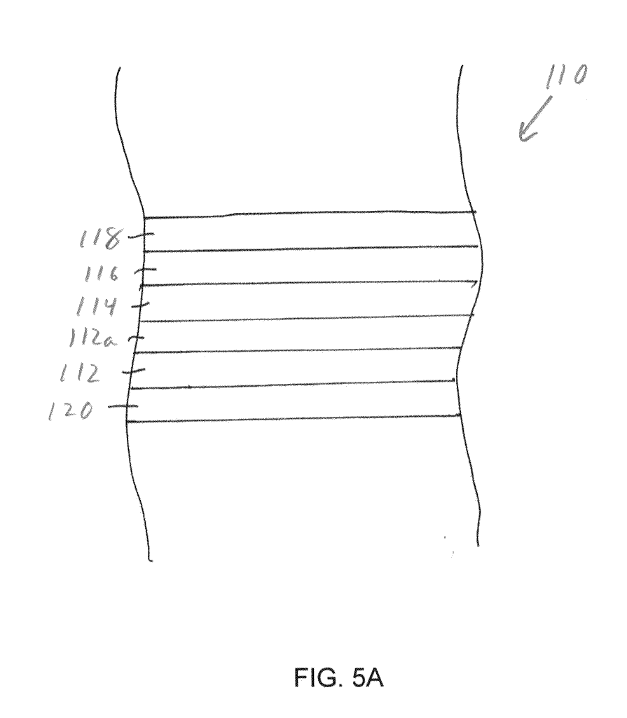

In a preferred embodiment, the present invention provides a layered structure 10 (FIG. 5) that includes a substrate 20, a first layer 12 connected to the substrate 20, a second layer 14 connected to the first layer 12, and a third layer 16 connected to the second layer 14. The layered structure 10 can optionally include a fourth layer 18 connected to the third layer 16.

The first layer 12 is a cementitious primer coat layer and is applied to the top surface of the substrate 20. The first layer 12 is formed from a mixture of cement and liquid acrylic resin. Preferably, the mixture forming the first layer 12 is made from a mixture of about 8 to 12 parts by volume cement to about 0.5 to 2 parts by volume liquid acrylic resin. More preferably the ratio of cement to liquid acrylic resin is about 10 parts by volume cement to about 1 part by volume liquid acrylic resin. When dried the first layer 12 is a hardened layer preferably about 1 to 2 Mils in thickness that includes cement and acrylic resin.

Optionally, the first layer 12 may formed from one or more sub-layers, such as a first sub-layer 12a and a second sub-layer 12b. The first sub-layer 12a can be an initial primer layer and formed as discussed above as first layer 12. The second sub-layer 12b can be a cementituous top coat primer layer that is formed from a mixture of cement and liquid acrylic resin. Preferably, the second sub-layer 12b is formed from a mixture that includes 20 parts by volume dry cement to 1 part by volume of a liquid acrylic resin. Alternatively, the mixture can include 16 to 24 parts by volume dry cement and 0.5 to 2 parts by volume of liquid acrylic resin, or 12 to 28 parts by volume dry cement and 1 part by volume of liquid acrylic resin. Preferably the ratio of cement to acrylic resin in the second sub-layer 12b is greater than the ratio or cement to acrylic resin in the first sub-layer 12a.

The second layer 14 is a coloring layer and includes a colorant. Preferably, the colorant is an acrylic colorant formed from a liquid or solid acrylic pigment. The acrylic colorant is formed from a mixture of acrylic pigment and water at a ratio of about 0.8 to 1.2 parts by volume acrylic pigment to about 16 to 24 parts by volume water, preferably about 0.6 to 1.4 parts by volume acrylic pigment to about 12 to 28 parts by volume water, and most preferably at about 1 part by volume acrylic pigment to about 20 parts by volume water.

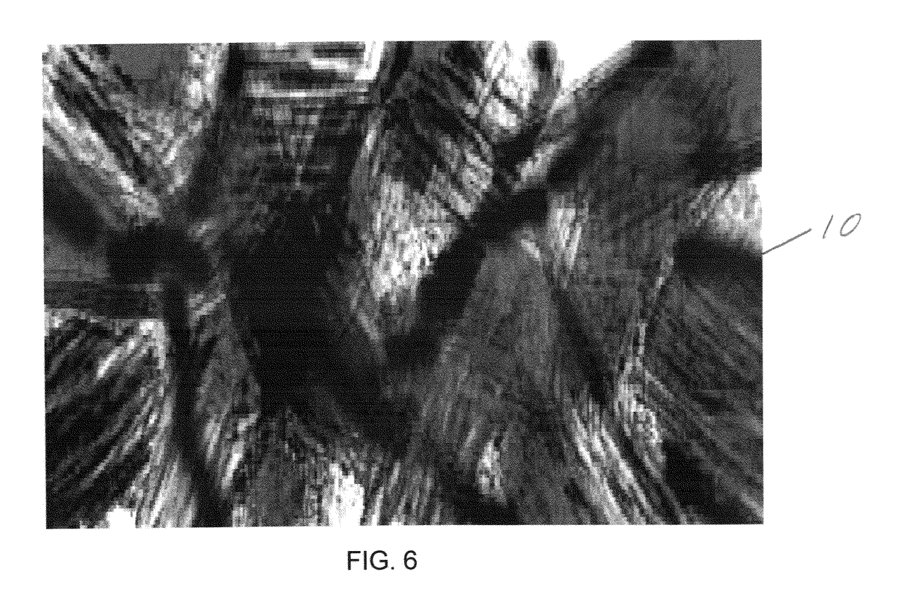

The second layer 14 is directly formed on the first layer 12 and lays adjacent the first layer 12. The second layer 14 is formed by applying the second layer mixture onto the first layer 12 is a random fashion in order to develop predetermined patterns and images. For example, the second layer mixture can be poured onto the first layer 12 in a random fashion, sprayed on, or rolled on using e.g., a roller. Such methods of applying the second layer 14 onto the first layer results in images having distinct patterns and shapes, as shown e.g., in FIGS. 6-9. The present invention is not limited to the foregoing means of applying the second layer 14 for producing distinct images, but other methods of applying the second layer 14 that results in distinctive images are applicable to the present invention. The second layer 14 can be about 0.01 to about 2 Mils thick, but can alternatively be more or less than 0.01 and 2 Mils.

Preferably, the acrylic liquid pigment applicable to the second layer 14 can include GOLDEN Fluid Acrylic Color by Golden Artist Colors, Inc of New Berlin, N.Y., PAREX USA's Liquid Colorants by ParexUSA of Anaheim, Calif., or any other acrylic liquid pigment suitable for the foregoing intended use.

In sum, the second layer 14 provides a colored image within the layered structure 10 that is visible. In other words, the second layer 14 is an image layer.

The third layer 16 is a sealing and protective coating layer. Preferably, the third layer 16 is an epoxy layer that includes an epoxy resin and an epoxy hardener. The third layer 16 is preferably formed from a mixture of about 3 parts by volume epoxy resin to about 1 part by volume hardener. In the alternative, the mixture can include about 2 to 4 parts by volume epoxy resin to about 0.5 to 1.5 parts by volume hardener, or about 1 to 5 parts by volume epoxy resin to about 0.1 to 2 parts by volume hardener.

The epoxy resin applicable to the third layer 16 can include: Ecopoxy Resin® by EcoPoxy Systems™ of Providence, Rhode Island, U.S. Composites Resin by U.S. Composites of West Palm Beach, Fla., West System Epoxy Resin by West System of Bay City, Mich., G/FlexEpoxy resin by West System of Bay City, Mich., or any other epoxy resin suitable for the foregoing intended use.

The fourth layer 18 is an optional wax layer that is used to help prevent micro scratching. The wax is preferably Copernicia cerifera (carnauba) wax. More preferably the wax is 100% Copernicia cerifera wax. The wax is applied preferably after 3 days hardening time of the first through third layers.

The wax applicable to the fourth layer 18 can include: Beall Tools Carnauba Wax by The Beall Tool Company of Newark, Ohio, MakingCosmetics Inc. Carnauba Wax by MakingCosmetics.com Inc. of Renton, Wash., Reed Carnauba Wax by Reed Wax of Reading, Mass., or any other wax suitable for the foregoing intended use.

The substrate 20 can be any substrate suitable for receiving the layered structure 10 or having the layered structure 10 formed thereon. For example, the substrate 20 can be a furniture piece such as a desk, a cabinet, a chair, or a table etc. or any an art piece such as a wall hanging or a sculpture etc. The substrate can also be a building material such as a wall, a door, a floor, a panel, or a column etc.

The substrate 20 serves as a base for the layered structure 10. The substrate 20 can be any material including, but not limited to, polymers (such as plastic), cement, metals, ceramics, composites, and the like, but is preferably wood.

The cement applicable to the first layer 12 can be e.g., Portland cement or any other cement suitable for the intended use.

Referring to FIG. 5A, in another preferred embodiment, the present invention provides a method of creating the layered structure 110. The method includes the steps of providing a substrate 120 and applying a first layer 112 that includes a mixture of cement and liquid acrylic resin (as described above) to the substrate 120. The first layer 112 is applied to the substrate 120 by any means suitable for the purpose. Preferably, the first layer 112 is applied by a brush and trowel. The first layer 112 is formed having a thickness of between 0.5 Mils and 5 Mils. More preferably the thickness is between 1 to 2 Mils. The applied first layer 112 is then allowed to dry for about 1 to 4 hours at about 70 degrees Fahrenheit to 80 degrees Fahrenheit and preferably for about 1 hour at about 75 degrees Fahrenheit. After the first layer 112 dries, the first layer 112 is buffed to reduce its surface roughness. The surface can be buffed e.g., with sandpaper to reduce imperfections on the surface and make a smoother final product.

After the first layer 112 is buffed, an optional sub-layer 112a can be applied to the first layer 112 by any means suitable for that purpose. Preferably, the sub-layer 112a is applied at a thickness of about 4 to 6 Mils and more preferably to a thickness of about 2 to 3 Mils. The applied sub-layer 112a is then allowed to dry. The sub-layer 112a is allowed to dry for about 6-12 hours at about 70 degrees Fahrenheit to 80 degrees Fahrenheit degrees and preferably for about 6 hours at about 75 degrees Fahrenheit. After the sub-layer 112a dries, the sub-layer 112a is buffed e.g., with sandpaper to reduce imperfections on the surface and make a smoother final product. With the first layer 112 and the sub-layer 112a, the thickness of the combined layers is about 1-5 Mils.

The method also includes the step of applying a second layer 114 onto the first layer 112 or 112a, if applicable. The second layer 114 is formed as described above for second layer 14. Alternatively, the second layer 114 can be formed from a mixture of acrylic pigment, water and epoxy.

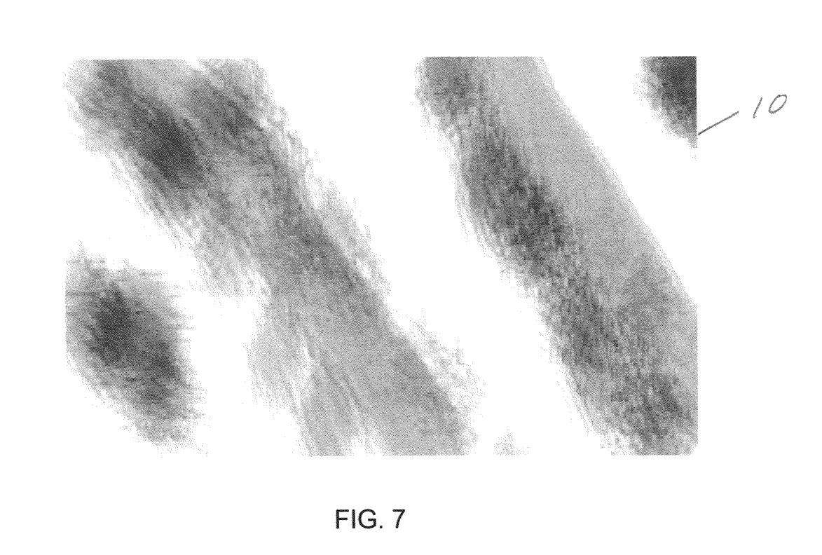

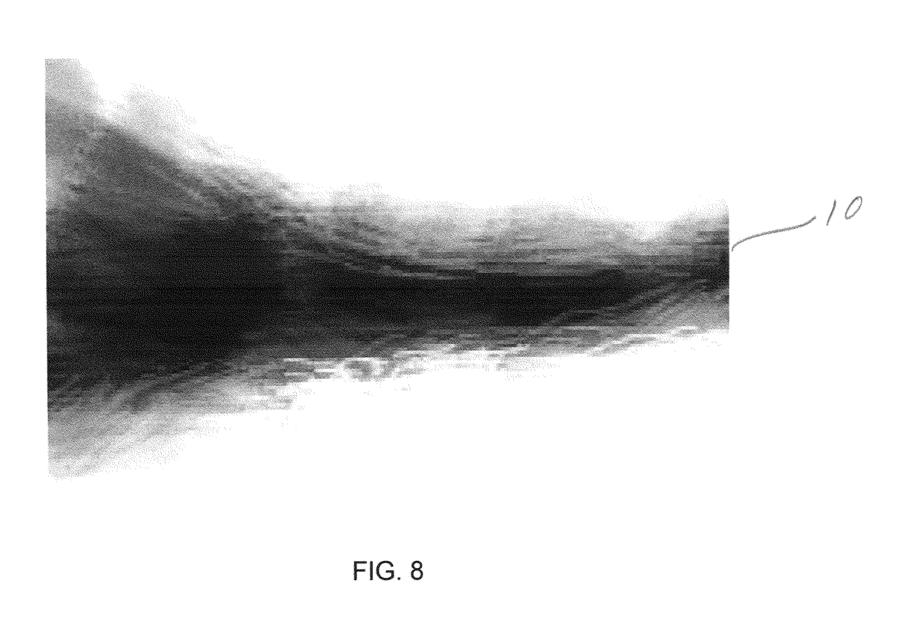

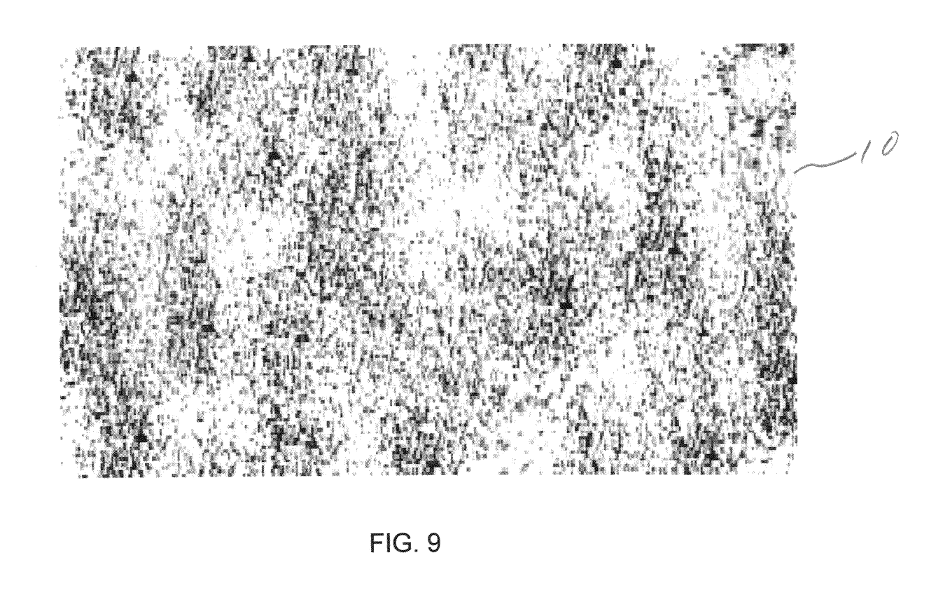

The second layer 114 or image layer is preferably applied to the first layer 112 by directly pouring the second layer mixture onto the first layer 112 in an undirected random fashion producing a unique aesthetic, as shown e.g., in FIG. 6, or by directly pouring the second layer mixture containing in a diagonal pattern to produce a diagonal strafing effect, as shown e.g., in FIG. 7. Further, the second layer 114 can be formed by pouring the second layer mixture in a horizontal-like manner or pattern to produce a horizontal strafing effect, as shown in e.g., FIG. 8. Furthermore, second layer 114 can be formed by applying the second layer mixture by a sprayer, such as a hand pumped mist sprayer, and/or rollers to produce a speckled effect, as shown e.g., in FIG. 9. The second layer 114 is applied at a thickness of about a 1/16- 1/4 inches, and more preferably at a thickness of about 1/16 inch and allowed to dry for about 2 to 5 days at about 70 degrees Fahrenheit to 80 degrees Fahrenheit, more preferably for about 3 days at about 75 degrees Fahrenheit.

After the second layer 114 is allowed to dry, a third layer 116 i.e., a protective layer is applied to the second layer 114. The third layer 116 preferably includes an epoxy mixture the same as that described above for third layer 16. The third layer 116 can be omitted if the second layer 114 includes the additional epoxy component, as described above.

After the third layer 116 is allowed to dry, the method includes an optional a fourth layer 118 that is formed on the third layer 116. The fourth layer 118 is formed as described above for fourth layer 18.

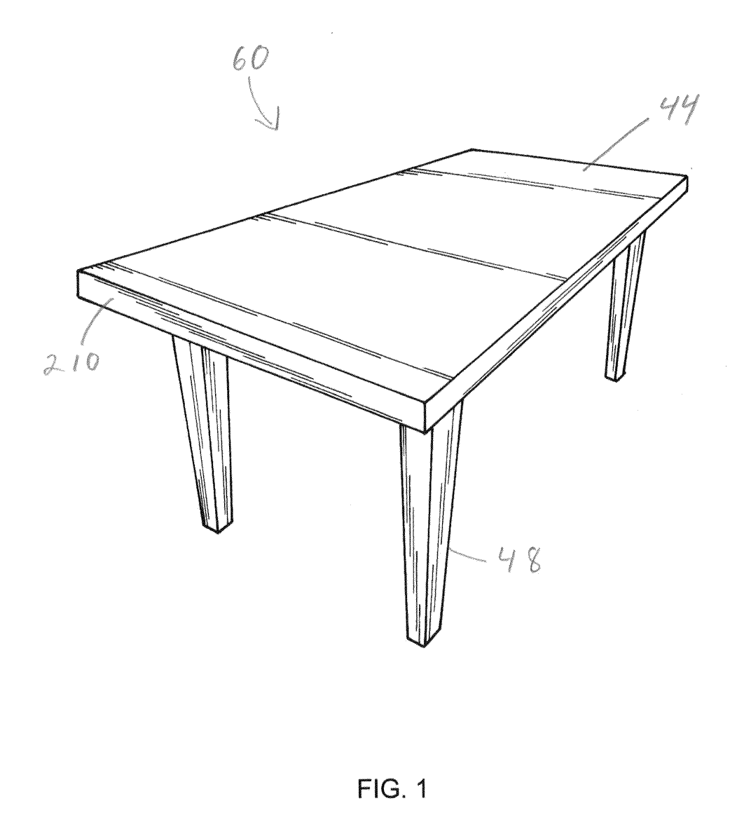

Referring to FIGS. 1-4, in yet another preferred embodiment, the invention provides for a convertible furniture piece 40 that includes a frame 42 and a cementitious layered structure 210. The frame 42 is configured to move between an extended configuration and a collapsed configuration. For exemplary purposes only and for convenience, the foregoing description of the present embodiment will be with respect to a table 60.

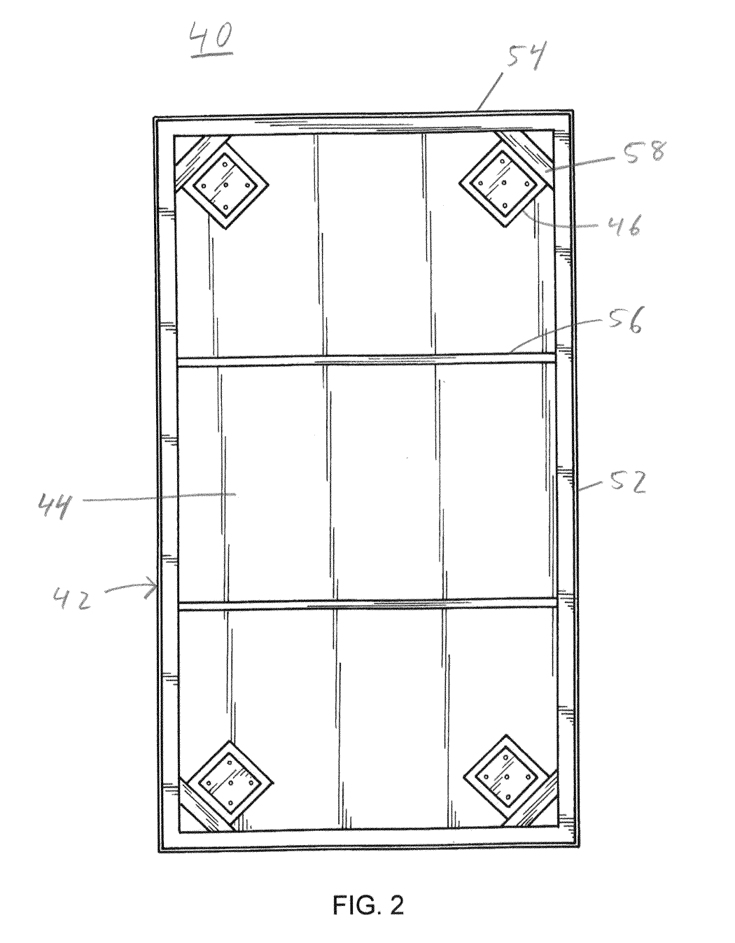

In the extended configuration, the frame 42 includes a substantially planar surface 44 and at least three mounting brackets 46, and at least three support members 48 releasably attached to the at least three mounting brackets 46. As shown in FIGS. 1 and 2, the table top 40 includes four mounting brackets 46 and four table legs 48 i.e., support members.

The table 60 has a planar surface 44 with a thickness of 1/2 inch to 1 inch. More preferably the planar surface 44 has a thickness of 3/4 inch. The planar surface 44 may be any shape suitable for the specific purpose. Preferably the planar surface 44 is a rectangle.

The frame 42 of the table 60 includes supports 52 and 54 along the outside “bottom” edge. Preferably, two 1 3/4 inch by 1 3/4 inch length supports 52 are cut to the length of the surface 44. Additionally two 1 3/4 inch by 3 3/4 inch width supports 54 are cut to the width of the surface 44 minus the width of the two length supports 52. In the alternative, 1-2 inch by 2-4 inch supports 52 and 54 may be used. The supports 52 and 54 are preferably made of wood. The supports 52 and 54 are glued to the planar surface 44 flush to the edges of the planar surface 44. The supports 52 and 54 are further secured to the planar surface 44 by additional fasteners. Preferably the fastener is a one inch staple.

The planar surface 44 is further supported by widthwise supports 56. Preferably the widthwise supports 56 are 1 inch by 2 inch and are securely attached to the planar surface 44 along the 1 inch side at 1/3 increments along the lengthwise measurement. Preferably the widthwise supports are secured to the planar surface by means of glue and staples. The widthwise supports 56 are preferably made of wood, but can be formed from any other material, such as metal, plastic or the like suitable for the foregoing stated use.

Each corner of the planar surface 44 has a corner support piece 58. In the case of a rectangular planar surface 44 the corner support piece 58 is cut with two 45 degree angles at each end. Each corner support piece 58 can be formed as a 1 inch by 2 inch piece, more or less than 1 and 2 inches. The corner support pieces 58 may be connected to the planar surface by any fastener readily known in the art can be used, which are suitable for the foregoing intended use.

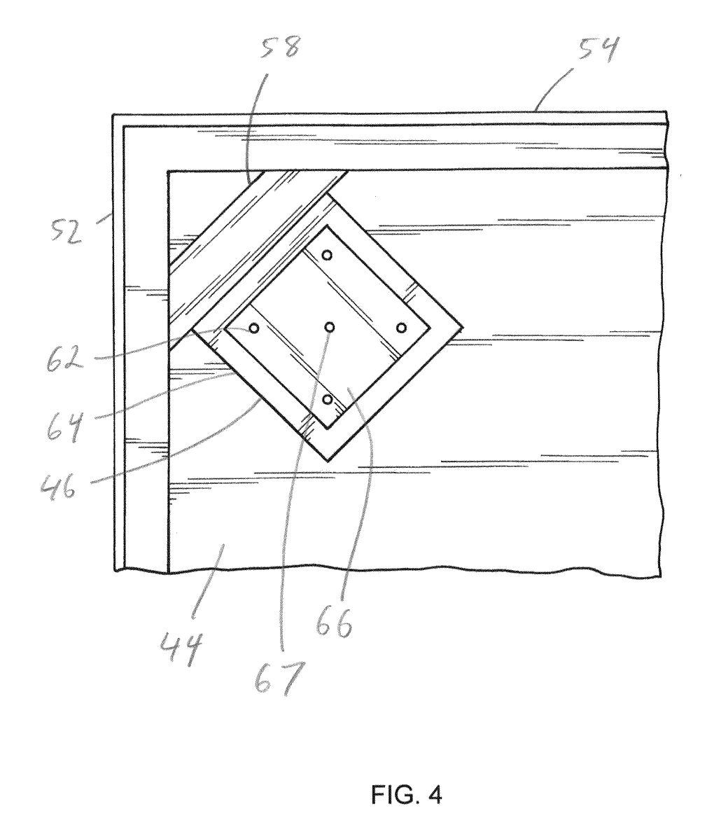

The at least 3 mounting brackets 46 are attached to the planar surface 44 about an underside of the planar surface 44 proximate to the corner supports 58. Referring to FIG. 4 each mounting bracket 46 is preferably comprises a block 64. Any material suitable for the purpose may be used for the block 64, but is preferably made of wood. Each block 64 is of a size capable of supporting at least 50 pounds. Preferably the block 64 has dimensions of 5 1/2 inch by 5 1/2 inch by 5/16th inch thick, but can be more or less. A metal plate 66 is connected to the block 64 to add support for mounting and carrying the weight of the table 60 on a wall. A hole 68 is drilled in the center of each wood block and each metal plate 66. A threaded insert 67 is set into the hole 68. Threaded inserts 67 are metal inserts that have wood threading on the exterior and metal threading on the interior that allow for the insert to be screwed into a wood part and accept a metal threaded screw to be inserted into it. The block 64 and metal plate 66 are preferably securely attached by means of four #8 screws, screwed into four holes 62 in the metal plate 66 and block 64 for that purpose.

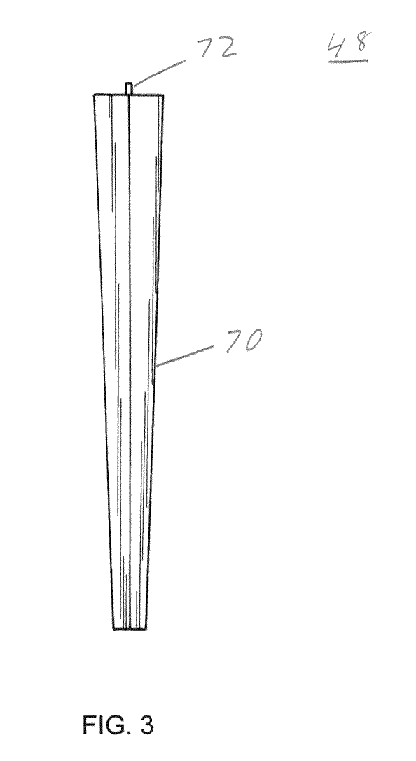

For the purposes of explanation and as best shown in FIG. 3 the supporting members are furniture legs e.g., table legs 70. Preferably, the table legs 70 are made of Alder wood. In the alternative the table legs 7 can be made from any type of wood including, but not limited to pine, cherry, elm, cedar, oak, spruce, beech, birch or any other material such as, metal, plastic, and the like suitable for the foregoing use.

Preferably, the table legs 70 are square four sided tapered legs, as shown in FIG. 3. In the alterative, the table legs 70 may have any number of sides, including being rounded. The table legs 70 measure about 3 1/2 inch by 3 1/2 inch wide with a height of about 29 inches. The table legs 70 also include a 2 1/2 inch deep hole drilled in the center of a top end of each leg.

A 3 inch long by 3/8 inch hanger bolt 72 is inserted into the wood. Alternatively, any other fastener may be used suitable for the foregoing use. A hanger bolt 72 is defined as a bolt with ⅔rds of its length being a wood thread and 1/3 of its length being a metal threaded screw. In the present embodiment, the wood screw end is screwed into the hole in the center of the top end of the leg until ⅝ths of an inch of the metal thread is remaining exposed from the table leg, as seen in FIG. 3. The table legs 70 are secured to at least three mounting brackets 62 by screwing in the exposed portion of the hanger bolt 72 into the threaded insert 67. The table legs 70 support the table 60 on a substantially horizontal surface, such as the ground.

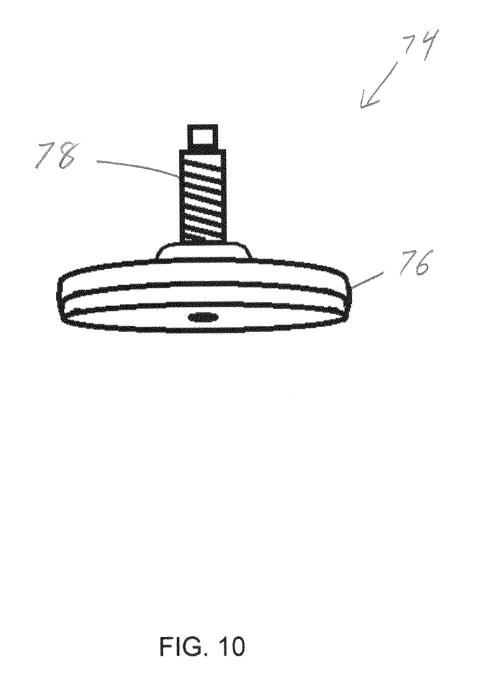

The table legs 70 include foot pads 74 (FIG. 10) that releasably attach to the bottom of the table legs. The food pads 74 have a padded potion 76 and a screw 78 extending from the padded portion for releasably attaching to a screw hole (not shown) in the bottom table leg 70 and to the threaded insert 67.

In the collapsed configuration, the frame 42 includes retaining members 74′ that releasably attach to each mounting bracket 46 for mounting the frame 42 to a vertical surface. In this embodiment, the foot pads 74 serve as the retaining members 74′. That is, in the collapsed configuration, the table legs 70 are separated from the mounting brackets, the foot pads 74 are separated from the table legs 70 and then at least two foot pads 74 are attached to the threaded insert 67 of at least two mounting brackets. Thereafter, a support member (not shown) such as a wire can be connected to each of the two retaining members 74′ for mounting the frame 42 to a vertical surface, such as a wall.

In other words, at least two foot pads may be screwed into at least two of the at least three mounting brackets 46. Preferably each foot pad is screwed into the threaded insert 67 of each mounting bracket 46. Any means suitable for securely mounting at least 100 pounds to a substantially vertical surface may be operatively connected to the foot pads. Preferably a braided steel wire (not pictured) is securely attached to the foot pads to allow the table surface to be mounted to a wall.

The table 60 further comprises a colored cementitioius layered structure 210. The cementitious layered structure 210 is formed on the frame 42. The colored cementitious layered structure 210 is can be as described above for layered structure 10. Preferably, colored cementitious layered structure 210 includes a first layer that includes a mixture of cement and acrylic resin connected to the frame 42, a second layer connected to the first layer, said second layer 14 including a colorant, and a third layer is connected to the second layer, the third layer 18 includes an epoxy.

It will be appreciated by those skilled in the art that changes could be made to the embodiments described above without departing from the broad inventive concept thereof. For example, additional components or layers can be added to the layered structure. It is to be understood, therefore, that this invention is not limited to the particular embodiment disclosed, but it is intended to cover modifications within the spirit and scope of the present invention as described above.

I/we claim:

1. A layered structure comprising:
a substrate;
a first layer connected to the substrate, the first layer including cement and an acrylic resin;
a second layer connected to the first layer, the second layer including a colorant; and
a third layer connected to the second layer, the third layer including an epoxy.

2. The layered structure of claim 1, further comprising a fourth layer connected to the third layer, the fourth layer including a wax, and
wherein the first layer comprises:
a first sub-layer that includes a mixture of cement and acrylic having a ratio of about 10 parts by volume cement to about 1 part acrylic resin; and
a second sub-layer connected to the first sub-layer that includes a mixture of cement and acrylic resin, wherein the ratio of cement to acrylic resin is greater than that of the first sub-layer.

3. The layered structure of claim 1, wherein the colorant is an acrylic colorant.

4. The layered structure of claim 1, wherein the wax is Copernicia cerifera wax.

5. The layered structure of claim 1, wherein the substrate is a furniture piece, a building material or an art work piece.

6. The layered structure of claim 5, wherein the furniture piece is a desk, a cabinet, a chair, or a table.

7. The layered structure of claim 5, wherein the art piece is a wall hanging or a sculpture.

8. The layered structure of claim 5, wherein the building material is a wall, a door, a floor, a panel or a column.

9. A method for creating a layered structure comprising the steps of:
providing a substrate;
applying a first layer that includes a mixture of cement and acrylic resin to the substrate;
applying a second layer that includes a colorant to the first layer; and
applying a third layer that includes an epoxy to the second layer.

10. The method of claim 9, further comprising the step of applying a forth layer that includes a wax to the third layer, and
wherein the step of applying the first layer further comprises applying a sub-layer first layer, the first sub-layer including a mixture of cement and acrylic resin.

11. The method of claim 10, wherein the step of applying the second layer, the second is applied using a roller or a sprayer.

12. The method of claim 9, wherein the first layer applied to a thickness of about 1-2 Mils.

13. The method of claim 10, wherein the second layer is applied after the first layer is dried, the third layer is applied after the second layer is dried and the fourth layer is applied after the third layer is applied.

14. A convertible furniture piece comprising:
a frame that is moveable between an extended configuration and a collapsed configuration, wherein in the extended configuration the frame includes:
a substantially planar surface,
at least three metallic mounting brackets connected to an underside of the substantially planar surface, and
at least three support members releasably attached to the at least three metallic mounting brackets for supporting the frame on a ground surface;
wherein in the collapsed configuration, the frame includes:
retaining members releasably attached to at least two of the at least three metallic mounting brackets for mounting the frame to a vertical surface, and wherein the support members are separated from the mounting brackets; and
a colored cementitious structure mounted to a topside of the substantially planar surface.

15. The convertible furniture piece of claim 14, wherein the at least three support members are furniture legs.

16. The convertible furniture piece of claim 15, wherein the retaining members are foot pads of the furniture legs.

17. The convertible furniture piece of claim 16, wherein the foot pads are releasably attached to a bottom of the furniture legs when the frame is in the extended configuration and releasably attached to the mounting brackets when the frame is in the collapsed configuration.

18. The convertible furniture piece of claim 17, wherein the mounting brackets each include a screw hole for receiving a screw extending from a top end of the support members for releasably attaching the support members thereto when the frame is in the extended configuration and for receiving a screw extending from the foot pad for releasably attaching the foot pads thereto when the frame is in the collapsed configuration.

19. The convertible furniture piece of claim 14, wherein the colored cementitious structure is a layered structure comprising:
a first layer that includes a mixture of cement and acrylic resin;
a second layer connected to the first layer, the second layer including a colorant; and
a third layer connected to the second layer, the third layer including an epoxy.

20. The convertible furniture piece of claim 19, wherein the layered structure further comprises a fourth layer connected to and adjacent the second layer, the fourth layer including an epoxy.
